(19) United States
(12) Patent Application Publication
(10) Pub. No.: US 2004/0226316 A1
(43) Pub. Date: Nov. 18, 2004

(54) Method for fabricating glass powder

(75) Inventor: Won Seok Moon, Seoul (KR)

Correspondence Address: TONY ROBERT MACE, 240 SOUTH 4TH STREET, ST. HELENS, OR, 97051, US

(73) Assignee: LG ELECTRONICS INC.

(21) Appl. No.: 10/747,212

(22) Filed: Dec. 30, 2003

(30) Foreign Application Priority Data
May 15, 2003 (KR) 30975/2003

(51) Int. Cl. C03B 19/10; C03B 8/02

(52) U.S. Cl. 65/17.2; 65/21.1

(57) ABSTRACT

A glass powder fabrication method is disclosed. Fine glass powder can be fabricated without a mechanical crushing process, a phenomenon that moisture is adsorbed to a particle surface of the glass powder or hydrated compound is generated is prevented, and a transmittance of a dielectric layer used for a PDP can be increased. A glass compound is dissolved in a solvent, the dissolved glass compound is atomized to create droplets, which are then melt to be vitrified.

### BACKGROUND OF THE INVENTION

1. Field of the Invention

The present invention relates to glass powder and, more particularly, to a method for fabricating glass powder used for plasma display panel (PDP).

2. Description of the Prior Art

In general, a plasma display panel (PDP) device receives much attention as a next-generation display device together with a thin film transistor (TFT), a liquid crystal display (LCD), an EL (Electro-Luminescence) device, an FED (Field Emission Display) and the like.

The PDP is a display device which uses a luminescent phenomenon according to an energy difference made when red, green and blue fluorescent materials are changed from an excited state to a ground state after being excited by 147 nm of ultraviolet rays which are generated as a He+X3 gas or N3+X3 gas is discharged from a discharge cell isolated by a barrier rib.

Thanks to its properties of facilitation in manufacturing from a simple structure, a high luminance, a high light emitting efficiency, a memory function, a high non-linearity, a 160° or wider optical angular field and the like, the PDP display device is anticipated to occupy a 40″ or wider large-scale display device markets.

A structure of the conventional PDP will now be described with reference to FIG. 1.

FIG. 1 is a sectional view showing a structure of a conventional PDP.

As shown in FIG. 1, the conventional PDP includes: a lower insulation layer 20 formed on a lower glass substrate 21; an address electrode 22 formed on the lower insulation layer 20; a lower dielectric layer 19 formed on the address electrode 22 and the lower insulation layer 20; an isolation wall 17 defined in a predetermined portion on the lower dielectric layer 19 in order to divide each discharging cell; a black matrix layer 16 formed on the isolation wall 17; a fluorescent layer 18 formed with a predetermined thickness on the side of the black matrix layer 16 and the isolation wall 17 and on the lower dielectric layer 19, and receiving ultraviolet ray and emitting each red, green and blue visible rays; a glass substrate 11; a sustain electrode 12 formed at a predetermined portion on the upper glass substrate 11 in a manner of vertically intersecting the address electrode 22; a bus electrode 12 formed on a predetermined portion on the sustain electrode 12; an upper dielectric layer 14 formed on the bus electrode 13, the sustain electrode 12 and the upper glass substrate 11; and a protection layer (MgO) 15 formed on the second upper dielectric layer 14 in order to protect the upper dielectric layer 14.

The operation of the conventional PDP will now be described.

First, as the upper glass substrate 11 and the lower glass substrate 21 of the conventional PDP, a high strain point glass substrate is used.

The lower insulation layer 20 is positioned on the lower glass substrate 21, the SLS glass substrate, and the address electrode 22 is positioned on the lower insulation layer 20.

The lower dielectric layer 19 positioned on the address electrode 22 and the lower insulation layer 20 blocks visible rays emitted toward the lower glass substrate 21.

In order to increase the luminous efficacy, a dielectric layer having a high reflectance is used as the lower dielectric layer 19. The lower dielectric layer 19, a translucent dielectric layer with a reflectance of 60% or above, minimizes loss of light.

Meanwhile, at a lower surface of the upper glass substrate 11, the high strain point glass substrate, there are formed the sustain electrode 12 positioned to vertically intersect the address electrode 22 and the bus electrode 13 positioned on the sustain electrode 12. And upper dielectric layer is positioned on the bus electrode 13.

The protection layer 15 is positioned on the upper dielectric layer 14 in order to prevent the upper dielectric layer 14 from being damaged due to generation of plasma. Herein, since the upper dielectric layer 14 is directly contacted with the sustain electrode 12 and the bus electrode 13, it must have a high softening temperature in order to avoid a chemical reaction with the sustain electrode 12 and the bus electrode 13.

The fluorescent layer 18, which is laminated in a sequential order of red, green and blue fluorescent materials, emits visible rays of a specific wavelength according to an intensity of ultraviolet rays according to plasma generated from a region between isolation walls 17.

The upper dielectric layer 14 of the PDP is formed such that low melting point glass powder is fabricated to paste, which is then printed and fired. The upper dielectric layer 14 accumulates electric charges generated when plasma is discharged, so that discharging can be maintained. In addition, the upper dielectric layer 14 is where the visible ray is transmitted, so it should have a high light transmittance and a suitable dielectric constant value.

The conventional method for fabricating the low melting point glass powder and dielectric layer used as the dielectric material will now be described.

First, oxide or carbonate are weighed in a pre-set composition ratio and mixed. The mixture is then put in a platinum crucible and melt at a temperature of 1200° C.˜1300° C., and then, the melt solution is quenched to create a glass flake.

Thereafter, the glass powder is crushed in a mechanical method such as a ball mill or a jet mill to produce glass powder.

Then, the glass powder is fabricated to paste, which is then printed and fired to form a dielectric layer. When the dielectric layer is formed, a surface state, a grain size and a shape of the fine glass powder directly affect the transmittance characteristics of the dielectric layer.

When the glass powder is fabricated by using the conventional method, in order to obtain glass powder of 1 μm or below, a wet crushing process using water or alcohol as a dispersive medium is performed. However, the wet crushing process is disadvantageous in that solvent molecules are adsorbed at the surface of the crushed glass powder, or a hydrated compound is generated from reaction between the solvent and the glass surface, degrading the characteristics of the fabricated glass powder.

In order to minimize the disadvantages, a dry crushing process is performed, in which, however, glass flakes are crushed in a state that a small amount of solvent is added in order to enhance a crushing efficiency and prevent power coagulation. Thus, with the dry crushing process, it is difficult to obtain glass powders of 2 μm or below, and the crushed glass powder has irregular shapes.

To sum up, as stated above, the wet crushing process for fabricating the glass powder has such a problem that since the solvent molecules are adsorbed to the surface of the crushed glass powder or the hydrated compound is generated due to the reaction between the solvent and the glass surface, the characteristics of the glass powder is degraded.

Meanwhile, the dry crushing process has such a problem that since the glass flakes are crushed in a state that a small amount of solvent is added for a crushing efficiency and powder coagulation prevention, glass powder of below 2 μm can be hardly obtained and the shape of the crushed glass powder is irregular.

Other conventional PDPs and their fabrication methods are disclosed in the U.S. Pat. No. 5,838,106 issued on Nov. 17, 1998, a U.S. Pat. No. 6,242,859 issued on Jun. 5, 2001, and a U.S. Pat. No. 6,599,851 issued on Jul. 29, 2003.

### SUMMARY OF THE INVENTION

Therefore, one object of the present invention is to provide a glass powder fabrication method capable of fabricating fine glass powder without performing a mechanical crushing process.

Another object of the present invention is to provide a glass powder fabrication method capable of preventing a phenomenon that moisture is adsorbed at a surface of particles of glass powder or a hydrated compound is generated.

Still another object of the present invention is to provide a glass powder fabrication method capable of increasing a light transmittance of a dielectric used for a PDP.

To achieve these and other advantages and in accordance with the purpose of the present invention, as embodied and broadly described herein, there is provided a method for fabricating glass powder including: dissolving glass compound in a solvent; atomizing the molten glass compound to create droplets; and melting the droplets so as to be vitrified.

To achieve the above objects, there is also provided a method for fabricating glass powder including: dissolving a compound of a glass composition in a solvent; atomizing the compound-molten solution to create droplets, and conveying the droplets to a flame reactor through a carrier gas; melting the droplets conveyed to the flame reactor to vitrify them; and collecting the vitrified glass particles.

The glass compound is at least one or more selected from the group consisting of chloride, nitride, hydrate, acetic acid compound, alkoxy compound and acid of an element constituting a glass composition, and the glass composition is one or more out of B, Al, Si, P, Mg, Ca, Sr, Ba, Zn, Pb and La.

The solvent of the glass powder is distilled water or alcohol.

The particle size of the glass powder is 200 nm or smaller.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing a structure of a PDP in accordance with a conventional art;

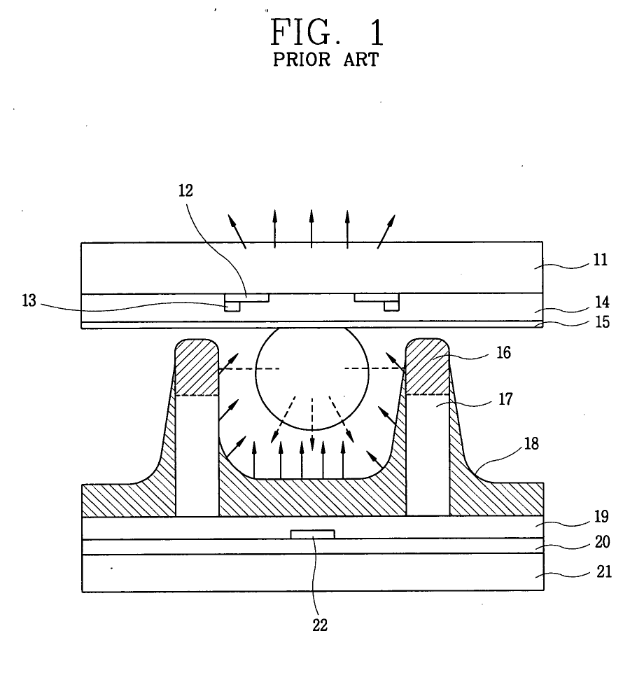

FIG. 2 is a flow chart of a method for fabricating low melting point glass powder in accordance with the present invention;

FIG. 3 is a view showing a structure of a flame reactor for atomizing and melting a glass solution; and

FIG. 4 shows a scanning electron microscope (SEM) photograph of glass powder fabricated according to the method of the present invention.

### DETAILED DESCRIPTION OF THE PREFERRED EMBODIMENTS

Reference will now be made in detail to the preferred embodiments of the present invention, examples of which are illustrated in the accompanying drawings.

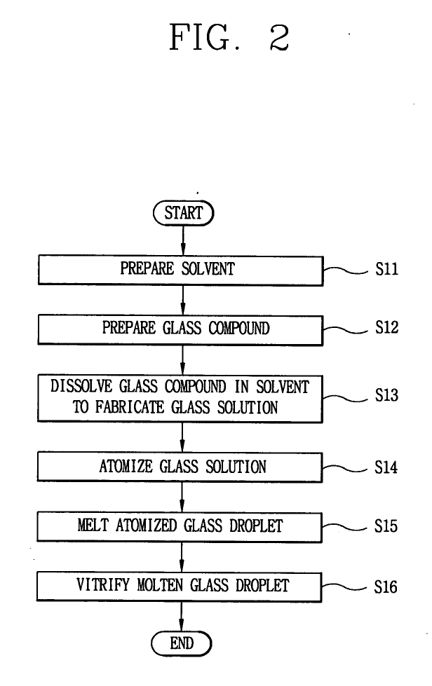

A glass powder fabrication method capable of fabricating fine glass powder without performing a mechanical crushing process and preventing a phenomenon that moisture is adsorbed to a particle surface of glass powder or hydrated compound is generated by dissolving a glass compound in a solvent, atomizing the dissolved glass compound to create droplets and melting the droplets to vitrify them, in accordance with a preferred embodiment of the present invention will now be described with reference to FIGS. 2 to 4.

The glass powder is low melting point glass powder, which can be used as a glass material that is able to increase a light transmittance of a dielectric layer when the dielectric layer of a PDP is fabricated.

FIG. 2 is a flow chart of a method for fabricating low melting point glass powder in accordance with the present invention.

With reference to FIG. 2, a method for fabricating low melting point glass powder includes: dissolving a compound of a glass composition (that is, a glass compound) in a solvent to fabricate a glass solution; atomizing the glass solution to convey it to a flame reactor; melting droplets conveyed to the flame reactor to vitrify them; and collecting the vitrified particles.

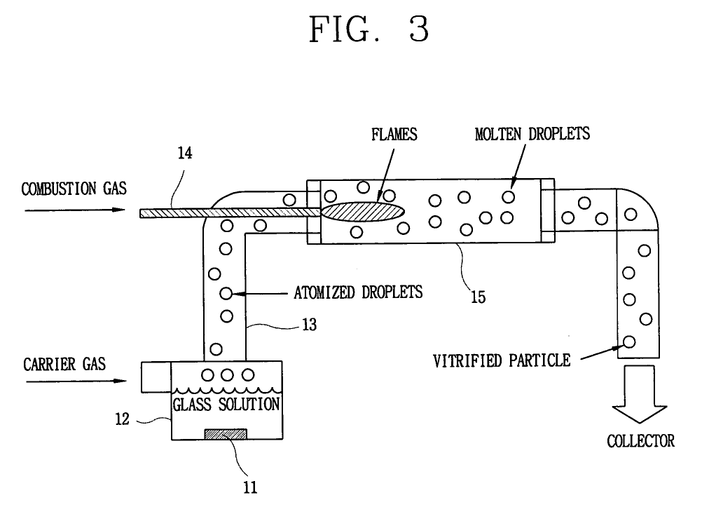

The flame reactor will now be described with reference to FIG. 3.

FIG. 3 is a view showing a structure of a flame reactor for atomizing and melting a glass solution.

As shown in FIG. 3, the flame reactor includes a container 12 for putting in the glass solution; a ultrasonic oscillator 11 for atomizing the glass solution in the container 12 through a connection pipe 13; a nozzle 14 for discharging a combustion gas; and a flame unit 15 for melting droplets atomized through flames of the combustion gas.

The molten droplets are exposed to an external temperature to be vitrified, and the vitrified fine glass particles are collected by a collector (e.g., bag filter).

As the combustion gas for generating flames, one of H₂, C₃H₆ or LPG, or a mixture of gases obtained by mixing O₂ to one of H₂, C₃H₆ and LPG. A flow amount of oxygen (O₂) is preferably 50 Ipm (liter per minute), and each flow amount of LPG, H₂ and C₃H₆ is 5 Ipm.

The glass solution melting process takes place in the flame unit 15 of the flame reactor generating flames by using a combustion gas. The temperature of the flame unit 15 is in the range of 1500° C.˜2500° C., so that glass solution (glass droplets) is melt for a short time, and as the molten droplets are discharged from the flame unit 15, it is cooled to amorphous glass. At this time, the initially atomized droplets are respectively formed to glass, and accordingly, fine glass powder can be obtained. Preferably, the temperature in the flame unit 15 is 1900° C.

A method for fabricating low melting point glass powder in accordance with the present invention will now be described with reference to FIGS. 2 and 3.

First, a solvent is prepared. As the solvent, water (distilled water (H₂O)) or alcohol is preferred. Preferably, the alcohol is one of methyl alcohol, ethyl alcohol, n-propyl alcohol, isopropyl alcohol, n-butyl alcohol and 2-methoxy alcohol.

In addition, an acid can be added according to a compound of the glass composition. In this case, available acids include hydrochloric acid, nitric acid, acetic acid, or the like, and preferably, the amount of addition of the acid is smaller than 0.1N (step S11).

A compound of the glass composition (glass compound) is prepared. Preferably, the glass composition (constituent) can be one or more selected from the group consisting of B, Al, Si, P, Mg, Ca, Sr, Ba, Zn, Pb and La. Preferably, the compound of the glass composition can be one or more selected from the group consisting of chloride, nitride, hydrate, acetate, alkoxy compound and acid (step S12).

Thereafter, the compound of the element of the glass composition is dissolved in the solvent to fabricate a glass solution. For example, in order to fabricate glass powder of PbO—B₂O₃—SiO₂—Al₂O₃ group, lead acetate (e.g., 0.28 mol/L), boric acid (e.g., 0.08 mol/L), tetra ethyl ortho silicate (e.g., 0.38 mol/L) and aluminum nitrate (e.g., 0.06 mol/L) as compounds of the glass composition are respectively weighed and the weighed each compound are dissolved in the solvent in order to fabricate a glass solution.

Preferably, the concentration of the glass solution is less than 3 mol/L on the basis of the total amount of the glass compound, and more preferably, the concentration of the glass solution is 0.5 mol/L˜2.0 mol/L.

If the concentration of the glass solution is 3 mol/L or more, the glass solution would be easily precipitated, so a uniform concentration in the glass solution can not be guaranteed (step S13).

After the glass solution is prepared, the glass solution is atomized to the flame reactor. The glass solution can be atomized by using a ultrasonic oscillation and/or a nozzle spraying method. For example, the fabricated glass solution can be atomized by using the ultrasonic oscillator or the nozzle spraying or using both methods. When the glass solution is atomized through the ultrasonic oscillation method, droplets each having a particle diameter of 1 μm ˜5 μm are formed, and an average particle diameter of the droplets is 2 μm (step S14).

Thereafter, the glass solution is moved in the droplet state to the flame unit 15 of the flame reactor by a carrier gas. As the carrier gas, nitrogen, argon or the like, an inactive gas, can be used. In addition, in order to make it easy to take place oxygen reaction with the carrier gas, oxygen can be used. Nitrogen, argon and oxygen or their mixture can be used.

A supply flow rate of the carrier gas should be in the range of 1 Ipm ˜20 Ipm (liter per minute), and preferably, 5 Ipm. If the supply flow rate of the carrier gas is greater than 20 Ipm, undesirably, the continuance time of droplets is rapidly reduced.

The atomized droplets conveyed to the flame reactor is melt in the flame unit 15, and the molten droplets are discharged (step S15). The discharged molten droplets are vitrified by an external temperature (step S16). That is, the glass droplets are molt by flames for a short time, and as the molten droplets get out of the flame unit 15, they are cooled to form amorphous glass. At this time, the initially atomized droplets are respectively formed to glass particles, thus obtaining fine glass powder. In this respect, preferably, a solvent is removed from the droplets and the solvent-removed droplets are melt.

Subsequently, the fine glass powder as formed is collected by using a bag filter or the like.

The reason why the particle size of the fine low melting point glass powder fabricated according to the present invention and the glass powder are favored as a glass material of a dielectric layer for a PDP will now be described.

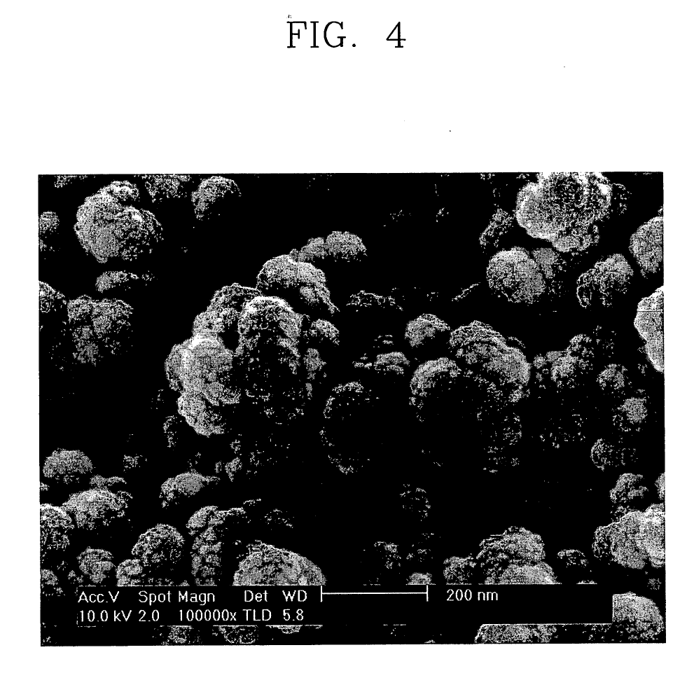

FIG. 4 shows a scanning electron microscope (SEM) photograph of glass powder fabricated according to the method of the present invention.

As shown in FIG. 4, since the fine low melting point glass powder fabricated according to the present invention has the particle size of below 200 nm, it can be usable as a glass material of a dielectric layer of a PDP. Namely, application of the fine low melting point glass powder with the particle size of 200 nm or smaller to the dielectric layer would promote an increase in the light transmittance of the dielectric layer.

As so far described, the method for fabricating glass powder used for plasma display panel (PDP) of the present invention has the following advantages.

That is, without a mechanical crushing process, glass compound is dissolved in a solvent, the dissolved glass compound is atomized to create droplets, which are then melt to vitrify them. Therefore, glass powder having a particle size of 200 nm or smaller can be fabricated.

In addition, a phenomenon that moisture is adsorbed to a particle surface of the glass powder or hydrated compound is generated is prevented.

Moreover, a transmittance of a dielectric layer used for a PDP can be increased. Namely, by applying glass powder having the particle size of 200 nm or smaller fabricated in accordance with the present invention to the dielectric layer, the transmittance of the dielectric layer can be increased.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for fabricating glass powder comprising:
dissolving glass compound in a solvent;
atomizing the molten glass compound to create droplets; and
melting the droplets so as to be vitrified;

2. The method of claim 1, wherein the glass compound includes one or more selected from the group consisting of chloride, nitride, hydrate, acetic acid compound, alkoxy compound and acid of an element constituting a glass composition, and the glass composition is one or more out of B, Al, Si, P, Mg, Ca, Sr, Ba, Zn, Pb and La.

3. The method of claim 1, wherein the solvent is distilled water or alcohol.

4. The method of claim 3, wherein the alcohol is one of methyl alcohol, ethyl alcohol, n-propyl alcohol, iso-propyl alcohol, n-butyl alcohol and 2-methoxy alcohol.

5. The method of claim 1, wherein the size of the vitrified particle is 200 nm or smaller.

6. A method for fabricating glass powder comprising:
dissolving a compound of a glass composition in a solvent;
atomizing the compound-molten solution to create droplets, and conveying the droplets to a flame reactor through a carrier gas;
melting the droplets conveyed to the flame reactor to vitrify them; and
collecting the vitrified glass particles.

7. The method of claim 6, wherein the solvent is distilled water or alcohol.

8. The method of claim 7, wherein the alcohol is one of methyl alcohol, ethyl alcohol, n-propyl alcohol, iso-propyl alcohol, n-butyl alcohol and 2-methoxy alcohol.

9. The method of claim 6, wherein the solvent includes one of hydrochloric acid, nitric acid and acetic acid, and the amount of acid is smaller than 0.1N.

10. The method of claim 6, wherein the glass composition includes one or more B, Al, Si, P, Mg, Ca, Sr, Ba, Zn, Pb and La.

11. The method of claim 6, wherein the glass compound includes one or more selected from the group consisting of chloride, nitride, hydrate, acetic acid compound, alkoxy compound and acid of an element constituting a glass composition.

12. The method of claim 6, wherein the concentration of the molten solution is within 3 mol/L on the basis of the total amount of compound of the glass composition.

13. The method of claim 6, wherein the molten solution is atomized by using a ultrasonic oscillation method or a nozzle spraying method, or by using both methods.

14. The method of claim 6, wherein an average particle diameter of the atomized droplets is 1 μm˜5 μm.

15. The method of claim 6, wherein the carrier gas is nitrogen, argon and oxygen, which are active gases, or their mixture.

16. The method of claim 15, wherein a supply flow rate of the carrier gas is 2 Ipm˜20 Ipm.

17. The method of claim 6, wherein the gas generating flames in the flame unit of the flame reactor is one or more of H₂, C₃H₆ and LPG, or a mixed gas obtained by mixing one or more of H₂, C₃H₆ and LPG and O₂, and a temperature of the flame unit is 1500° C.˜2500° C. or higher than 2500° C.

18. The method of claim 6, wherein the size of the collected glass particle is 200 nm or smaller.

19. The method of claim 6, wherein droplets melt by the flame reactor are cooled to be vitrified.
